(19) United States
(12) Patent Application Publication
(10) Pub. No.: US 2025/0191158 A1
(43) Pub. Date: Jun. 12, 2025

(54) INDOOR IMAGE QUALITY EVALUATION METHOD OF IMAGE SENSOR

(71) Applicant: Samsung Electronics Co., Ltd., Suwon-si (KR)

(72) Inventors: Kichrl Park, Suwon-si (KR); Duwon Lee, Goyang-si (KR); Yoojeong Seo, Suwon-si (KR); Seungwan Jeon, Suwon-si (KR); Dongoh Kim, Suwon-si (KR); Yongkoo Park, Suwon-si (KR); Byoungho Kong, Suwon-si (KR); Sungsu Kim, Suwon-si (KR); Dongyoung Song, Suwon-si (KR)

(73) Assignees: Samsung Electronics Co., Ltd., Suwon-si (KR); Posan Industry Co.,Ltd., Goyang-si (KR)

(21) Appl. No.: 18/947,021

(22) Filed: Nov. 14, 2024

(30) Foreign Application Priority Data
Dec. 8, 2023 (KR) 10-2023-0178041

(51) Int. Cl. G06T 7/00; H04N 23/66

(52) U.S. Cl. CPC G06T 7/0002; H04N 23/66; G06T 2207/30168

(57) ABSTRACT

An indoor image quality evaluation method includes A) setting an imaging scenario and capturing a master image, B) moving an imaging robot to an imaging position of the master image, C) matching the field of view of an image sensor S to the field of view of the master image, D) adjusting an imaging environment for a subject by using an adjustable light, E) capturing an image to be evaluated, by using the image sensor S, and F) evaluating the image to be evaluated by determining whether the image is of acceptable or unacceptable quality based on a degree of similarity between the image to be evaluated and the master image.

### CROSS-REFERENCE TO RELATED APPLICATION

This application is based on and claims priority under 35 U.S.C. § 119 to Korean Patent Application No. 10-2023-0178041, filed on Dec. 8, 2023, in the Korean Intellectual Property Office, the disclosure of which is incorporated by reference herein in its entirety.

### BACKGROUND

Aspects of the inventive concept relate to an indoor image quality evaluation method capable of carrying out an image quality evaluation on an image sensor indoors, and more particularly, to an indoor image quality evaluation method including A) setting an imaging scenario and capturing a master image, B) moving an imaging robot to an imaging position of the master image, C) matching the field of view of an image sensor to the field of view of the master image, D) adjusting an imaging environment for a subject/object (e.g., sculpture) by using an illumination means, and E) capturing an image to be evaluated, by using the image sensor.

An image sensor is a sensor configured to convert light indicating image information input to a camera lens into a digital signal and is widely used in cellular phone cameras, digital cameras, closed circuit televisions (CCTVs), autonomous vehicles, and the like. Such an image sensor undergoes various image quality evaluation procedures in the development stage, and for this purpose, various image quality evaluation methods have been developed.

For example, Korean Patent Registration No. 10-1090594 (Dec. 1, 2011) discloses an image quality evaluation method of an image sensor, capable of implementing various color temperatures by using a light source having a single color temperature and a filter, and implementing a wide illumination environment while constantly maintaining these color temperatures, the light source being an artificial light source used for image sensor evaluation.

In addition, Korean Patent Registration No. 10-1673203 (Nov. 1, 2016) discloses a testing device for testing camera image quality, capable of smoothly performing a focusing work or an image test of a camera module having a super-wide-angle lens (a fisheye lens) with an imaging angle of greater than 180 degrees by applying a geodesic dome design scheme to the testing device.

However, these existing evaluation methods and devices were developed to evaluate the image quality of an image of a limited subject captured under a limited condition. Therefore, to evaluate the image quality of an image of each of various subjects captured under various outdoor conditions, experimenters go outdoors, image various subjects, then return to an indoor laboratory, and carry out an evaluation work on the captured images.

### SUMMARY

According to the related art, because an image quality evaluation work on an image sensor is carried out outdoors, much time and costs are required, and in particular, a case where an image quality evaluation work cannot be carried out in bad weather frequently occurs according to weather conditions.

One or more aspects of the inventive concept may provide a new indoor image quality evaluation method capable of dramatically saving time and costs required for image quality evaluation of an image sensor, by providing an environment in which various subjects are imaged indoors under the same condition as outdoors to evaluate the image quality of the image sensor.

One or more aspects of the inventive concept may also provide an indoor image quality evaluation method capable of easily evaluating the image quality of an image sensor regardless of a weather condition or a working time by carrying out a work for capturing an image to evaluate the image quality of the image sensor and an evaluation work on the captured image one-stop without changing locations.

According to an aspect of the inventive concept, an indoor image quality evaluation method of an image sensor, using an imaging robot on which the image sensor to be evaluated is mounted and which autonomously travels, an indoor studio in which the imaging robot moves, subjects arranged in the indoor studio, and an adjustable light configured to adjust imaging environments for the subjects, includes: operation A) setting an imaging scenario for the image sensor and capturing, using a camera having a different image sensor than the image sensor being evaluated, a plurality of master images of the subjects, each master image of the plurality of master images corresponding to a respective subject of the subjects, and storing the imaging scenario in a database; operation B) moving the imaging robot to an imaging position of a master image of the plurality of master images; operation C) matching a field of view (FOV) of an image of a subject of the plurality of subjects to be captured by the image sensor to an FOV of the master image by using a robot arm of the imaging robot by comparing, in real-time, the FOV of the master image with the FOV of the image of the subject until the two FOVs match; operation D) adjusting the adjustable light to match an imaging environment for the subject to an imaging environment set in the imaging scenario; operation E) imaging, by using the image sensor, the subject to generate an image to be evaluated and comparing, by a management server, the image to be evaluated to the master image corresponding thereto to evaluate the image to be evaluated; and operation F) evaluating the image to be evaluated by determining whether the image is of acceptable or unacceptable quality based on a degree of similarity between the image to be evaluated and the master image

Operation A) may include inputting the plurality of master images and the imaging scenario to a separate management server and operations B) to E) may include wirelessly controlling each of the imaging robot, the adjustable light, and the image sensor by using the management server.

According to an aspect of the inventive concept, a method of evaluating an image captured by an image sensor includes: moving an imaging robot to a position in an indoor studio corresponding to a position of a camera at which a master image has been captured, wherein the image sensor is mounted on a robot arm of the robot; using the robot arm, adjusting a field of view (FOV) of the image sensor to correspond to the FOV of the master image; adjusting an illumination condition of an illumination environment of the indoor studio to correspond to the illumination condition of the master image; capturing an image of a subject using the image sensor; evaluating the captured image by comparing the captured image to the master image.

According to an aspect of the inventive concept, an image evaluation system includes an imaging robot comprising a robot moving portion and a robot arm; an image sensor mounted on the robot arm; an indoor studio in which the imaging robot is configured to move; subjects arranged in the indoor studio; an adjustable light configured to adjust imaging environments of the subjects; and a management server configured to: set an imaging scenario for the image sensor and capture, using a camera that has an image sensor different from the image sensor being evaluated, a plurality of master images of the subjects, each master image of the plurality of master images corresponding to a respective subject of the subjects; move the imaging robot to an imaging position of a master image of the plurality of master images; match a field of view (FOV) of an image of a subject of the plurality of subjects to be captured by the image sensor to an FOV of the master image by using the robot arm of the imaging robot while checking the image in real-time; adjust the adjustable light to match an imaging environment for the subject to an imaging environment set in the imaging scenario; by using the image sensor, capture an image of the subject to generate an image to be evaluated and compare the image to be evaluated to the master image corresponding thereto to evaluate the image to be evaluated; and evaluating the image to be evaluated by determining whether the image is of acceptable or unacceptable quality based on a degree of similarity between the image to be evaluated and the master image.

### BRIEF DESCRIPTION OF THE DRAWINGS

Embodiments of the inventive concept will be more clearly understood from the following detailed description taken in conjunction with the accompanying drawings in which:

FIG. 1 is a perspective view of an imaging robot according to an embodiment;

FIG. 2 is a top view of an indoor studio according to an embodiment;

FIGS. 3 and 4 are real photographs illustrating subject sculptures and an illumination means provided in the indoor studio;

FIG. 5 is a block diagram illustrating a management server according to an embodiment; and

FIG. 6 is a flowchart of an indoor image quality evaluation method according to the inventive concept.

### DETAILED DESCRIPTION OF THE EMBODIMENTS

Hereinafter, the inventive concept is described in detail with reference to the accompanying drawings. However, because the accompanying drawings illustrate embodiments, the scope of the inventive concept is not limited to the embodiments. In addition, even though a feature may be essential to carry out the inventive concept, if the feature is disclosed in the related art or could be easily carried out by those of ordinary skill in the art from well-known features, a particular description of the feature is omitted.

In addition, the term such as “ . . . unit” or “ . . . means” among components belonging to the inventive concept refers to a unit that performs at least one function or operation and may be implemented as hardware, software, or as a combination thereof. In addition, when a certain part “includes” a certain component, this indicates that the part may further include another component in accordance with circumstances.

An indoor image quality evaluation method of an image sensor, according to the inventive concept, uses an imaging robot 10 on which an image sensor S to be evaluated is mounted and which autonomously travels, an indoor studio 20 in which the imaging robot 10 moves, subjects (e.g., subject sculptures) 30 arranged in the indoor studio 20, and an adjustable light (e.g., an illumination means) 40 configured to provide different imaging environments to the subjects 30.

In the present disclosure, the term “master image” indicates an image of each of the subjects 30 captured in advance to evaluate the image quality of the image sensor S through comparison. In addition, the term “image to be evaluated” indicates an image of each subject 30 captured using the image sensor S to be evaluated according to the inventive concept. The subject 30 is also used to capture in advance the corresponding master image.

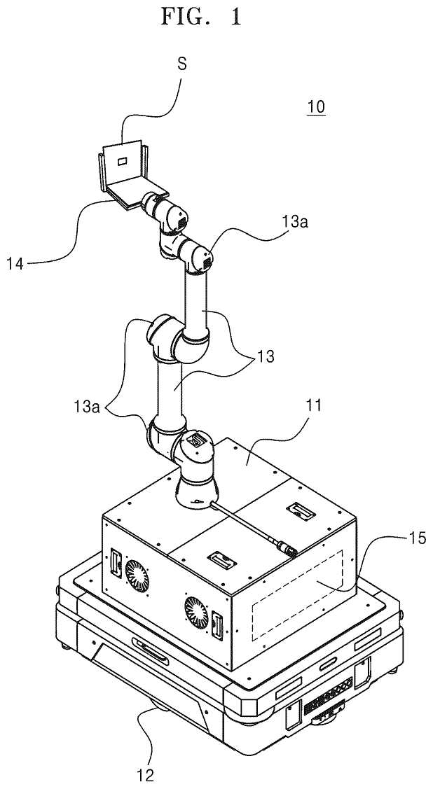

FIG. 1 illustrates the imaging robot 10 according to an embodiment, which may include a body portion 11 (e.g., a body), a robot moving portion 12 provided beneath the body portion 11, a robot arm 13 provided on the body portion 11 and having a plurality of joint portions 13a (e.g., joints), and a sensor jig 14 provided to the distal end of the robot arm 13 and supporting the image sensor S.

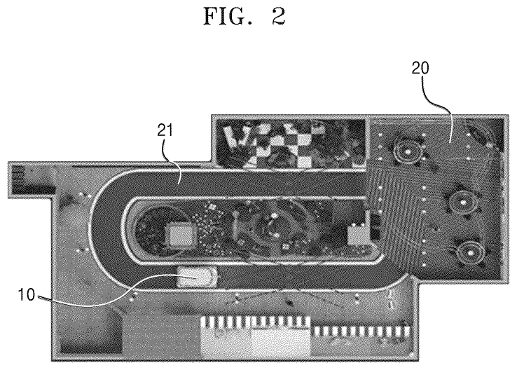

The indoor studio 20 may have an imaging zone of a certain area provided indoors, as shown in FIG. 2, and include a circulation road 21 on which the imaging robot 10 moves. In the imaging zone, position coordinates are set in the X-axis and Y-axis directions such that the position of each subject 30 is recognizable. In an initial stage before image evaluation is performed, the imaging robot 10 may map the position coordinates of the indoor studio 20 while traveling along the circulation road 21.

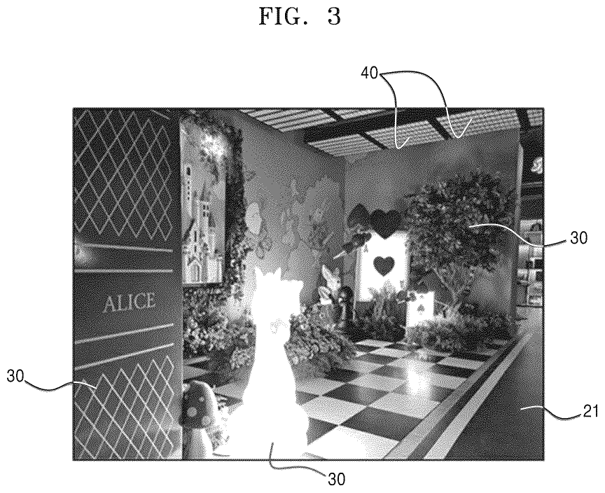

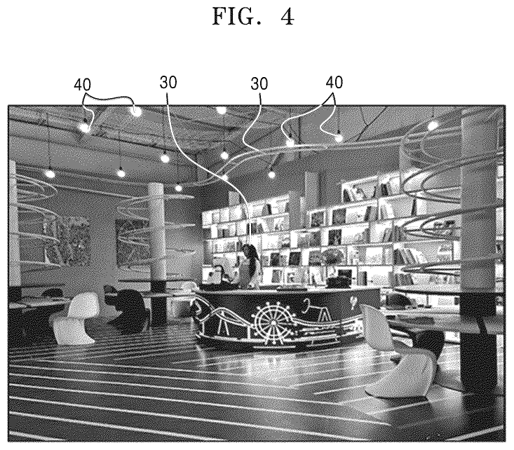

The subjects 30 are arranged along the circulation road 21 of the indoor studio 20 such that an image to be evaluated is captured using the image sensor S. The subjects 30 are designed to enable the evaluation of at least one of the high dynamic range (HDR), the detail sharpness, the moire, and a color error of the image to be evaluated. For example, the subjects 30 may be implemented as a cafe or restaurant interior, a city downtown, an amusement park, a park, a clock tower, a statue, a street tree, and the like, as shown in FIGS. 3 and 4.

Herein, HDR indicates a technique of expanding a dynamic range (DR) of an image as if a human were actually viewing a subject, by making bright points brighter and dark points darker in a digital image. As a reference, the term “DR” indicates a range from the brightest point to the darkest point.

A DR perceived by the eyes of a human being is about 10,000 knit, but an image input to an existing typical display is about 100 knit, and thus, implementing realistic image quality is limited. Therefore, HDR evaluation is used to evaluate whether images having various shades of brightness existing in the real world from the intense light of the sun to the star light in the dark night sky represent the same color temperatures as the real color temperatures through the contrast ratio of an image.

In addition, the term “moire” also refers to an interference pattern, a wave pattern, or a grid pattern and indicates a stripe pattern visually made due to a cycle difference (e.g., a difference between periods of the patterns) when regularly repeated shapes are superimposed several times. A subject of which the moire is to be evaluated has a stripe pattern or a grid pattern densely arranged. A moire phenomenon may be evaluated by observing whether a stripe pattern or a grid pattern is cut or overlayed on another in an image obtained by imaging the subject.

In addition, a subject of which the detail sharpness is to be evaluated may include at least one of an artificial plant, a circular clock, a mannequin face, and a character plate to evaluate how sharply the detail of the subject is represented and how sharply the outline of the subject is discriminated from a background.

The adjustable light 40 provides imaging environments of different illuminances and color temperatures to each subject 30 and may include a combination of daylight-colored, orange and white, and incandescent bulb-colored light-emitting diodes (LEDs). The adjustable light 40 may be provided on the ceiling of the indoor studio 20 or between the subjects 30 and may provide an imaging environment corresponding to, for example, a day time, a night time, a sunrise time, or a sunset time by properly combining the light intensities of the LEDs of the adjustable light 40.

The indoor image quality evaluation method according to the inventive concept may include A) setting an imaging scenario and capturing a master image, B) moving the imaging robot 10 to an imaging position of the master image, C) matching the field of view (FOV) of the image sensor S to the FOV of the master image, D) adjusting an imaging environment for a subject 30 by using the illumination means 40, and E) capturing an image to be evaluated, by using the image sensor S.

First, in operation A), an imaging scenario for the image sensor S is set and a plurality of master images are captured for the subjects 30. The plurality of master images may be obtained by using a typical digital camera (e.g., one that has been properly calibrated and is fully operational) to sequentially image the subject sculptures 30.

In addition, the imaging scenario may include position information of each master image and an imaging environment for and the number of imaging times of an image to be evaluated corresponding to each master image. The imaging environment may include the illuminance and the color temperature of light supplied to each subject 30.

Next, in operation B), according to the imaging scenario, the imaging robot 10 is moved to an imaging position of a master image captured in advance. For example, precise imaging positions (e.g., a position at which a camera was located when capturing an image, also described as an image capture device position) for master images captured in the indoor studio 20 may be stored, and may be communicated to the imaging robot 10. The imaging robot 10 may be autonomously moved by the robot moving portion 12. The robot moving portion 12 may be the same as a moving means of a typical autonomous robot and may include, for example, a motor, moving wheels, and a steering mechanism.

Next, in operation C), the FOV of an image of the subject sculpture 30 captured by the image sensor S is matched to the FOV of the master image by using the robot arm 13 of the imaging robot 10 while checking the image in real-time. The robot arm 13 has the plurality of joint portions 13a and has the sensor jig 14 provided at the distal end of the robot arm 13 to mount the image sensor S on the sensor jig 14. Therefore, the image sensor S may approach or be moved away from the sculpture 30 by an operation of the robot arm 13 to adjust an FOV. The robot arm 13 may be movable using one or more motors or actuators to adjust positions and/or orientations of each of the joint portions 13a. The joint portions 13a may be moved together or independently of each other using the one or more motors or actuators. The motors and joints of the robot arm 13 and the motor and steering mechanism of the robot moving portion 12 may be autonomously controlled and/or may be controlled wirelessly, for example. For example, the motors and joints of the robot arm 13 and the motor and steering mechanism of the robot moving portion 12 may be controlled wirelessly by an operator.

Next, in operation D), an imaging environment for the subject 30 is checked and the adjustable light 40 is used to adjust the imaging environment for the subject 30 according to the imaging environment set in the imaging scenario. By doing this, the illuminance and the color temperature of light supplied to the subject 30 are matched to the imaging environment set in the imaging scenario.

Next, in operation E), an image to be evaluated is generated by using the image sensor S to image the subject 30 and is compared to a corresponding master image and evaluated. Herein, for the same subject 30, several images to be evaluated may be captured while changing an imaging environment. In addition, at least one of HDR, moire, detail sharpness, and color error is compared and evaluated with respect to each master image and a corresponding image to be evaluated.

According to aspects inventive concept, the imaging robot 10, the adjustable light 40, and the image sensor S may be wirelessly controlled using a separate management server 50. In this case, in operation A), the master image and the imaging scenario may be input to the management server 50, and operations B) to E) may be controlled by the management server 50 according to the imaging scenario. To this end, the body portion 11 of the imaging robot 10 may further include a wireless communication interface 15 configured to communicate with the management server 50.

The management server 50 may control movement and an operation of the imaging robot 10 and the illuminance and the color temperature of the adjustable light 40 according to the imaging scenario that is preset, and control the imaging robot 10 to capture an image to be evaluated by matching the FOV of the image sensor S to the FOV of a master image that is previously captured. The management server 50 may be at one side of the indoor studio 20 or in an adjacent separate space, or may otherwise be separated from the indoor studio 20 by an arbitrary distance.

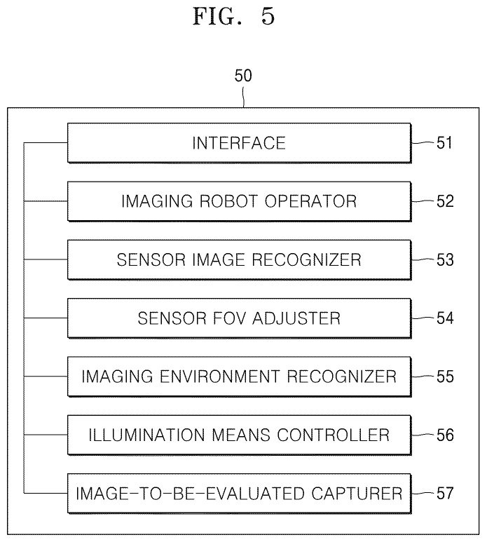

FIG. 5 is a block diagram of the management server 50 according to an embodiment, which may include an interface 51, an imaging robot operator 52, a sensor image recognizer 53, a sensor FOV adjuster 54, an imaging environment recognizer 55, an illumination means controller 56, and an image-to-be-evaluated capturer 57.

Although not illustrated, the management server 50 may include one or more of the following components: at least one central processing unit (CPU) configured to execute computer program instructions to perform various processes and methods, random access memory (RAM) and read only memory (ROM) configured to access and store data and information and computer program instructions, input/output (I/O) devices configured to provide input and/or output to a processing controller (e.g., keyboard, mouse, display, speakers, printers, modems, network cards, etc.), and storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium) where data and/or instructions can be stored. In addition, the management server 50 may include antennas, network interfaces that provide wireless and/or wire line digital and/or analog interface to one or more networks over one or more network connections (not shown), a power source that provides an appropriate alternating current (AC) or direct current (DC) to power one or more components of the management server 50, and a bus that allows communication among the various disclosed components of the management server 50.

The management server 50 may be a computer (or several interconnected computers) and may include, for example, one or more processors configured by software, such as a CPU, a graphics processor (GPU), a controller, etc., and may include various functional modules such as an interface 51, an imaging robot operator 52, a sensor image recognizer 53, a sensor FOV adjuster 54, an imaging environment recognizer 55, an illumination means controller 56, and an image-to-be-evaluated capturer 57. Each functional module described herein may include a separate computer, or some or all of the functional module may be included in and share the hardware of the same computer. Connections and interactions between the modules described herein may be hardwired and/or in the form of data (e.g., as data stored in and retrieved from memory of the computer, such as a register, buffer, cache, storage drive, etc., such as part of an application programming interface (API)). The functional modules may each correspond to a separate segment or segments of software (e.g., a subroutine) which configure the computer of the management server 50, and/or may correspond to segment(s) of software that also correspond to one or more other functional modules (or units) described herein (e.g., the functional modules (or units) may share certain segment(s) of software or be embodied by the same segment(s) of software). As is understood, “software” refers to prescribed rules to operate a computer, such as code or script.

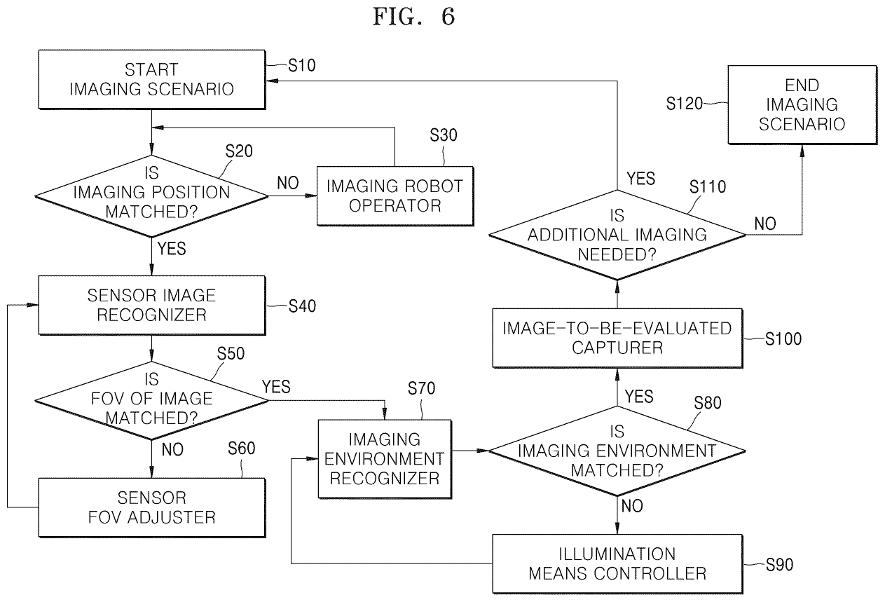

FIG. 6 is a flowchart illustrating execution of an imaging scenario by using the management server 50, according to the inventive concept. Unless otherwise indicated, the steps of the disclosed method may be performed in any order.

First, in step S10, the interface 51 provides a means for a user to input an imaging scenario with pre-captured master images in operation A). The interface 51 may include a screen with various conditions of input windows, a keyboard, and the like, and the screen may include a touch screen. The pre-captured master images may be captured in advance by the user or by another operator. The imaging scenario may include a position of the camera used to capture the pre-captured master images, a field of view of the camera used to capture the pre-captured master images, and one or more illumination conditions present when the pre-captured master images are captured. For example, the pre-captured master images and the position of the camera may be provided by the camera or by an operator of the camera to a computer and stored. For example, the illumination conditions present when the pre-captured master images are captured may be provided by the adjustable light 40 or by an operator performing the capturing of the pre-captured master images to the computer and stored. The user may then input the stored imaging scenario to the interface 51. As another example, the user may manually enter the imaging scenario to the interface 51.

The input imaging scenario may be stored, e.g., in a database connected to the management server 50.

Then, in step S20, the imaging robot operator 52 may determine whether the imaging robot 10 is located in a position that matches the position of a pre-captured master image. If the imaging robot 10 is located in a matching position, then the operation proceeds to step S40.

Next, in operation B) and in step S30, if the imaging robot 10 is not located in a matching position, then the imaging robot operator 52 may move the imaging robot 10 to an imaging position of a master image such that the image sensor S captures an image to be evaluated according to the imaging scenario. To this end, the imaging robot operator 52 may control the robot moving portion 12 by using the position coordinates of the indoor studio 20.

In step S40, the sensor image recognizer 53 may recognize an image of a subject sculpture 30 captured by the image sensor S in operation C) in a state in which the imaging robot 10 arrives at the imaging position of the master image. In addition, at step S50, the sensor FOV adjuster 54 may determine whether the FOV of the image to be captured by the image sensor S matches the FOV of the master image. If the FOV of the image to be captured by the image sensor S does not match the FOV of the master image, then at step S60, the sensor FOV adjuster 54 may control the robot arm 13 of the imaging robot 10 such that the FOV of the image captured by the image sensor S matches the FOV of the master image. The sensor FOV adjuster 54 may match both the FOVs according to an essential matrix scheme while checking an image of the subject 30 captured by the image sensor S in real-time. If the FOV of the image to be captured by the image sensor S matches the FOV of the master image, then the operation proceeds to step S70.

At step S70, the imaging environment recognizer 55 may recognize (e.g., measure) an imaging environment (e.g., an illumination condition), i.e., the illuminance of the subject 30 and the color temperature of light supplied to the subject 30 in operation D). At step S80, the illumination means controller 56 may determine whether the recognized imaging environment matches the imaging environment included in the imaging scenario. If the recognized imaging environment does not match the imaging environment included in the imaging scenario, then at step S90, the illumination means controller 56 may control the illuminance and the color temperature of the adjustable light 40 to match the imaging environment for the subject 30 to an imaging environment included in the imaging scenario. If the recognized imaging environment matches the imaging environment included in the imaging scenario, then the operation proceeds to step S100.

Finally, at step S100, the image-to-be-evaluated capturer 57 may control the image sensor S to generate an image to be evaluated by imaging the subject 30 in operation E). As shown in FIGS. 3 and 4, the subject 30 may include a plurality of different objects. In the present disclosure, terms such as ‘first’ and ‘second’ may be used to distinguish a plurality of subjects 30. The image to be evaluated is sequentially stored in the management server 50.

In this manner, a first image to be evaluated corresponding to a first master image is captured for a first subject. At step S110, the management server 50 determines whether additional imaging is needed, e.g., of the same subject under a different imaging environment or of a different subject. Then, if additional imaging is needed, the imaging robot 10 moves to an imaging position of a second master image according to the imaging scenario, and a second image to be evaluated corresponding to the second master image is captured for a second subject (or, e.g., for the first sculpture under a different imaging scenario or under a different imaging environment) in the same procedures beginning with step S10. In one or more embodiments, instead of moving to another imaging position, the imaging robot 10 may remain in the same imaging position and the imaging environment may be changed so that a second image may be captured of the first subject under the different imaging environment.

If additional imaging is not needed, then the operation ends at step S120.

If the imaging robot 10 fully moves along the circulation road 21 of the indoor studio 20 to complete all imaging procedures according to the imaging scenario, the management server 50 may directly evaluate images to be evaluated by comparing the images to be evaluated to master images or transmit the images to be evaluated and the master images to a separate image analysis server (not shown).

For example, the management server 50 may determine whether the image sensor S mounted on the sensor jig 14 is of acceptable or unacceptable quality based on a degree of similarity between the images to be evaluated and the master images. For example, the management server 50 may adjust an attribute of the image sensor S mounted on the sensor jig 14 based on a degree of similarity between the images to be evaluated and the master images. For example, the management server 50 may determine whether the image sensor S mounted on the sensor jig 14 is of acceptable or unacceptable quality by determining whether an image to be evaluated is of acceptable or unacceptable quality based on a degree of similarity between the image to be evaluated and a corresponding master image.

While the inventive concept has been particularly shown and described with reference to embodiments thereof, it will be understood that various changes in form and details may be made therein without departing from the spirit and scope of the disclosure.

What is claimed is:

1. An indoor image quality evaluation method of an image sensor, using an imaging robot on which the image sensor is mounted and which autonomously travels, an indoor studio in which the imaging robot moves, subjects arranged in the indoor studio, and an adjustable light configured to adjust imaging environments for the subjects, the indoor image quality evaluation method comprising:
operation A) setting an imaging scenario for the image sensor and capturing, using a camera having a different image sensor than the image sensor being evaluated, a plurality of master images of the subjects, each master image of the plurality of master images corresponding to a respective subject of the subjects, and storing the imaging scenario in a database;
operation B) moving the imaging robot to an imaging position of a master image of the plurality of master images;
operation C) matching a field of view (FOV) of an image of a subject of the plurality of subjects to be captured by the image sensor to an FOV of the master image by using a robot arm of the imaging robot by comparing, in real-time, the FOV of the master image with the FOV of the image of the subject until the two FOVs match;
operation D) adjusting the adjustable light to match an imaging environment for the subject to an imaging environment set in the imaging scenario;
operation E) imaging, by using the image sensor, the subject to generate an image to be evaluated and comparing, by a management server, the image to be evaluated to the master image corresponding thereto to evaluate the image to be evaluated; and
operation F) evaluating the image to be evaluated by determining whether the image is of acceptable or unacceptable quality based on a degree of similarity between the image to be evaluated and the master image.

2. The indoor image quality evaluation method of claim 1, wherein operation A) comprises inputting, from the database, the plurality of master images and the imaging scenario to the separate management server and operations B) to E) comprise wirelessly controlling each of the imaging robot, the adjustable light, and the image sensor by using the management server.

3. The indoor image quality evaluation method of claim 1, wherein the imaging scenario comprises position information of each master image of the plurality of master images, an imaging environment for an image to be evaluated corresponding to each master image, and a number of imaging times of the image to be evaluated corresponding to each master image, and
the imaging environment comprises an illuminance of each subject and a color temperature of light supplied to each subject.

4. The indoor image quality evaluation method of claim 1, wherein operation A) comprises mapping, by the imaging robot, position coordinates of the indoor studio while traveling along a circulation road of the indoor studio.

5. The indoor image quality evaluation method of claim 1, wherein, in operation D), the adjustable light provides imaging environments of different illuminances and color temperatures to each subject by combining daylight-colored, orange and white, and an incandescent bulb-colored light-emitting diodes (LEDs).

6. The indoor image quality evaluation method of claim 1, wherein operation E) comprises comparing and evaluating, by the separate management server, at least one of high dynamic range (HDR), moire, detail sharpness, and color error with respect to each master image and the corresponding image to be evaluated.

7. A method of evaluating an image captured by an image sensor, the method comprising:
moving an imaging robot to a position in an indoor studio corresponding to a position of a camera at which a master image has been captured, wherein the image sensor is mounted on a robot arm of the robot;
using the robot arm, adjusting a field of view (FOV) of the image sensor to correspond to the FOV of the master image;
adjusting an illumination condition of an illumination environment of the indoor studio to correspond to the illumination condition of the master image;
capturing an image of a subject using the image sensor;
evaluating the captured image by comparing the captured image to the master image.

8. The method of claim 7, further comprising:
measuring the illumination condition of the illumination environment; and
adjusting the illumination condition of the illumination environment by comparing the measured illumination condition to the illumination condition of the master image.

9. The method of claim 7, further comprising:
controlling the imaging robot to move along a circulation road in the indoor studio to capture a plurality of images using the image sensor; and
evaluating the plurality of captured images by comparing each of the plurality of captured images to a respective master image of a plurality of master images.

10. The method of claim 9, wherein each of the plurality of captured images corresponds to a subject of the image and an illumination condition of the image.

11. The method of claim 7, wherein a management server controls the imaging robot and the illumination condition of the illumination environment.

12. The method of claim 7, wherein the illumination condition includes an illuminance of the subject and a color temperature of light supplied to the subject.

13. The method of claim 7, further comprising mapping, by the imaging robot, position coordinates of the indoor studio while traveling along a circulation road of the indoor studio.

14. The method of claim 7, wherein an adjustable light provides illumination conditions of different illuminances and color temperatures to each subject by combining daylight-colored, orange and white, and incandescent bulb-colored light-emitting diodes (LEDs).

15. The method of claim 7, wherein the evaluating of the captured image comprises evaluating at least one of a high dynamic range (HDR), a moire, a detail sharpness, and a color error of the captured image with respect to the master image.

16. An image sensor evaluation system comprising:
an imaging robot comprising a robot moving portion and a robot arm;
an image sensor mounted on the robot arm;
an indoor studio in which the imaging robot is configured to move;
subjects arranged in the indoor studio;
an adjustable light configured to adjust imaging environments of the subjects; and
a management server configured to:
set an imaging scenario for the image sensor and capture, using a camera that has an image sensor different from the image sensor being evaluated, a plurality of master images of the subjects, each master image of the plurality of master images corresponding to a respective subject of the subjects;
move the imaging robot to an imaging position of a master image of the plurality of master images;
match a field of view (FOV) of an image of a subject of the plurality of subjects to be captured by the image sensor to an FOV of the master image by using the robot arm of the imaging robot while checking the image in real-time;
adjust the adjustable light to match an imaging environment for the subject to an imaging environment set in the imaging scenario;
by using the image sensor, capture an image of the subject to generate an image to be evaluated and compare the image to be evaluated to the master image corresponding thereto to evaluate the image to be evaluated; and
evaluating the image to be evaluated by determining whether the image is of acceptable or unacceptable quality based on a degree of similarity between the image to be evaluated and the master image.

17. The system of claim 16, wherein the management server is configured to set the imaging scenario by setting position information of each master image of the plurality of master images, an imaging environment for an image to be evaluated corresponding to each master image, and a number of imaging times of the image to be evaluated corresponding to each master image, and
wherein the imaging environment comprises an illuminance of each subject and a color temperature of light supplied to each subject.

18. The system of claim 16, wherein the imaging robot is configured to map position coordinates of the indoor studio while traveling along a circulation road of the indoor studio.

19. The system of claim 16, wherein the adjustable light is configured to provide imaging environments of different illuminances and color temperatures to each subject by combining daylight-colored, orange and white, and incandescent bulb-colored light-emitting diodes (LEDs).

20. The system of claim 16, wherein the management server is configured to compare and evaluate at least one of a high dynamic range (HDR), a moire, a detail sharpness, and a color error with respect to each master image and the corresponding image to be evaluated.
